(19) United States
(12) Patent Application Publication
(10) Pub. No.: US 2016/0205427 A1
(43) Pub. Date: Jul. 14, 2016

(54) USER TERMINAL APPARATUS, SYSTEM, AND CONTROL METHOD THEREOF

(71) Applicant: SAMSUNG ELECTRONICS CO., LTD., Suwon-si (KR)

(72) Inventors: Seung-il YOON, Yongin-si (KR); Jee-hoon KA, Suwon-si (KR); Sang-jin KIM, Suwon-si (KR); Dae-hyun NAM, Anyang-si (KR); Kyung-hoon LEE, Seoul (KR); Kyung-hee JUNG, Suwon-si (KR); Hyun-kyu YUN, Seoul (KR); Byung-jo JUN, Seongnam-si (KR)

(73) Assignee: SAMSUNG ELECTRONICS CO., LTD., Suwon-si (KR)

(21) Appl. No.: 14/995,355

(22) Filed: Jan. 14, 2016

(30) Foreign Application Priority Data
Jan. 14, 2015 (KR) 10-2015-0006885

(51) Int. Cl. H04N 21/2668; H04N 21/81; H04N 21/466; H04N 21/437; H04N 21/45; H04N 21/442; G06F 3/0484; H04N 21/41

(52) U.S. Cl. CPC H04N 21/2668; G06F 3/04842; H04N 21/8133; H04N 21/4126; H04N 21/437; H04N 21/4532; H04N 21/4516; H04N 21/44204; H04N 21/4668

(57) ABSTRACT

A user terminal apparatus is provided. The user terminal apparatus includes: a communicator configured to communicate with a display apparatus and a server; and a processor configured to determine whether to receive additional information from the server based on the context information of the display apparatus received from the display apparatus, and to control the communicator to transmit, to the display apparatus, a signal for controlling a status of the display apparatus based on at least one of the context information and the additional information.

### CROSS-REFERENCE TO RELATED APPLICATION(S)

This application claims priority under 35 U.S.C. §119(a) from Korean Patent Application No. 10-2015-0006885 filed on Jan. 14, 2015 in the Korean Intellectual Property Office, the entire disclosure of which is hereby incorporated by reference.

### BACKGROUND

1. Field

Exemplary embodiments relate to a user terminal apparatus, a system, and a control method thereof, and more particularly, to a user terminal apparatus which controls a status of a display apparatus, a system, and a control method thereof.

2. Related Art

With the development of electronic technologies, various kinds of display apparatuses have been developed. In particular, display apparatuses such as televisions (TVs), personal computers (PCs), laptops, tablet PCs, mobile phones, and MP3 players are widely used to such an extent that they can be found in most households.

In order to meet consumer demand for new functions and new types of displays, an effort to develop new types of display apparatuses is ongoing.

In particular, there is an increasing demand for enabling information to be exchanged by interworking between the display apparatus and various user terminal apparatuses, and a method for a user to more efficiently control the display apparatus according to a user's taste, a history of usage, a status of the display apparatus, or the like based on exchanged information using a user's terminal apparatus.

However, in the related art, there is a lack of a user terminal apparatus which controls a display apparatus by efficiently exchanging information between the user terminal apparatus, the display apparatus, and a server.

### SUMMARY

Aspects of the exemplary embodiments address at least the above-mentioned problems and/or disadvantages and may provide at least some of the advantages described below.

Accordingly, an aspect of the exemplary embodiments provides a user terminal apparatus which receives additional information from a server based on context information of a display apparatus, and controls the status of the display apparatus based on at least one of the context information and the additional information, a system, and a control method thereof.

According to an aspect of an exemplary embodiment, a user terminal apparatus is provided. The user terminal apparatus includes: a communicator configured to communicate with a display apparatus and a server; and a processor configured to determine whether to receive additional information from the server based on context information of the display apparatus received from the display apparatus, and to control the communicator to transmit, to the display apparatus, a signal for controlling a status of the display apparatus based on at least one of the context information and the additional information.

In response to the additional information being received from the server, the processor may be configured to control the communicator to transmit, to the display apparatus, a content reproduction signal for reproducing a predetermined content in the display apparatus based on the received additional information and the context information.

The processor may be configured to control the communicator to transmit, to the server, a content request signal for transmitting the predetermined content from the server to the display apparatus based on the received additional information.

The user terminal apparatus may further include a display, and the processor may be configured to control the display to display a user interface screen including at least one content based on the received additional information.

The processor may be configured to control the communicator to transmit, to the display apparatus, a content reproduction signal corresponding to a content selected by a user manipulation from at least one content displayed on the user interface screen, and to control the communicator to transmit, to the server, a content request signal for transmitting the selected content from the server to the display apparatus.

The content request signal may include connection information for communicating with the display apparatus.

The context information of the display apparatus may include at least one of information on content currently displayed on the display apparatus, information on a viewing history, and information on a power status, and the additional information may include at least one of information on a recommended content related to the displayed content, information on a preference based on the viewing history, and information on a display mode based on the power status.

According to an aspect of another exemplary embodiment, a system is provided. The system includes: a display apparatus; a user terminal apparatus configured to control the display apparatus; and a server configured to communicate with at least one of the user terminal apparatus and the display apparatus, and the user terminal apparatus is configured to determine whether to receive additional information related to context information of the display apparatus from the server based on the context information of the display apparatus received from the display apparatus, and to transmit a signal for controlling a status of the display apparatus based on at least one of the context information and the additional information to the display apparatus.

In response to the additional information being received, the user terminal apparatus may be configured to transmit, to the server, a content request signal for transmitting a content from the server to the display apparatus, the server may be configured to transmit a content corresponding to the received content request signal to the display apparatus, and the display apparatus may be configured to display the received content.

The content request signal may include connection information for communicating with the display apparatus.

The server may be configured to receive information on user activity performed in the user terminal apparatus by communicating with the user terminal apparatus, generate user preference information based on the information on the user activity and a content displayed on the display apparatus, and transmit information on a content recommended based on the user preference information to the display apparatus.

The server may be configured to determine whether the information on the user activity has a positive relation or negative relation to the displayed content, and generate the user preference information based on the determined relation.

According to an aspect of another exemplary embodiment, a control method of a user terminal apparatus is provided. The control method includes: receiving context information of a display apparatus from the display apparatus; determining whether to receive additional information related to the context information from the server based on the received context information; and transmitting, to the display apparatus, a signal for controlling a status of the display apparatus based on at least one of the context information and the additional information.

The transmitting may include, in response to the additional information being received from the server, transmitting, to the display apparatus, a content reproduction signal for reproducing a predetermined content in the display apparatus based on the received additional information and the context information.

The control method may further include transmitting, to the server, a content request signal for transmitting the predetermined content from the server to the display apparatus based on the received additional information.

The control method may further include displaying a user interface screen including at least one content based on the received additional information.

The control method may further include transmitting, to the display apparatus, a content reproduction signal corresponding to a content selected by a user manipulation from at least one content displayed on the user interface screen, and transmitting, to the server, a content request signal for transmitting the selected content from the server to the display apparatus.

The content request signal may include connection information for communicating with the display apparatus.

The context information of the display apparatus may include at least one of information on a content currently displayed on the display apparatus, information on a viewing history, and information on a power status, and the additional information may include at least one of information on a recommended content related to the displayed content, information on a preference based on the viewing history, and information on a display mode based on the power status.

According to an aspect of an exemplary embodiment, a non-transitory computer readable medium comprising computer executable instructions executable by a processor is provided. The computer executable instructions may cause the computer to perform: receiving, from a display apparatus, context information of the display apparatus; determining whether to retrieve additional information from the server based on the received context information; and transmitting a content reproduction signal to cause the display apparatus to reproduce a predetermined content based on the retrieved additional information and the context information.

The computer executable instructions may further cause the computer to perform: transmitting, to the server, a content request signal to cause the server to transmit the predetermined content to the display apparatus based on the received additional information.

The content request signal may include connection information to be used by the server to communicate with the display apparatus.

In accordance with the exemplary embodiments, the user may easily obtain content recommended based on context information of the display apparatus through the user terminal apparatus, and easily view the recommended content through the display apparatus.

### BRIEF DESCRIPTION OF THE DRAWINGS

The above and other aspects, features, and advantages of certain exemplary embodiments of the present disclosure will be more apparent from the following description taken in conjunction with the accompanying drawings, in which:

FIG. 1A is a view to illustrate a display system according to an exemplary embodiment;

FIG. 1B is a view to illustrate a display system according to an exemplary embodiment;

FIG. 2A is a block diagram showing a configuration of a user terminal apparatus according to an exemplary embodiment;

FIG. 2B is a block diagram showing a configuration of a user terminal apparatus according to another exemplary embodiment;

FIG. 3 is a block diagram showing a configuration of a user terminal apparatus 100′ according to another exemplary embodiment;

FIG. 4 is a block diagram showing a configuration of a storage according to an exemplary embodiment;

FIGS. 5 and 6 are flowchart showing a process of exchanging information in a system according to an exemplary embodiment;

FIGS. 7 to 9 are views showing additional information which is received according to context information according to various exemplary embodiments;

FIG. 10 is a block diagram showing a configuration of a server according to an exemplary embodiment;

FIGS. 11A to 11C and 12A and 12B are views to illustrate types of user activities according to various exemplary embodiments;

FIGS. 13A and 13B and 14 are views to illustrate a method for searching a recommendation content according to an exemplary embodiment;

FIGS. 15A to 15D are views to illustrate a method for providing a User Interface (UI) of a user terminal apparatus according to various exemplary embodiments;

FIG. 16 is a timing chart to illustrate a method for connecting to an access point (AP) according to an exemplary embodiment; and

FIG. 17 is a flowchart to illustrate a control method of a user terminal apparatus according to an exemplary embodiment.

### DETAILED DESCRIPTION OF EXEMPLARY EMBODIMENTS

Hereinafter, exemplary embodiments will be described in greater detail with reference to the accompanying drawings. In the following description, well-known functions or constructions are not described in detail because they would obscure the exemplary embodiments with unnecessary detail. The terms used herein are defined according to the functions of the exemplary embodiments. Thus, the terms may vary depending on user's or operator's intension and usage. That is, the terms used herein must be understood based on the descriptions made herein.

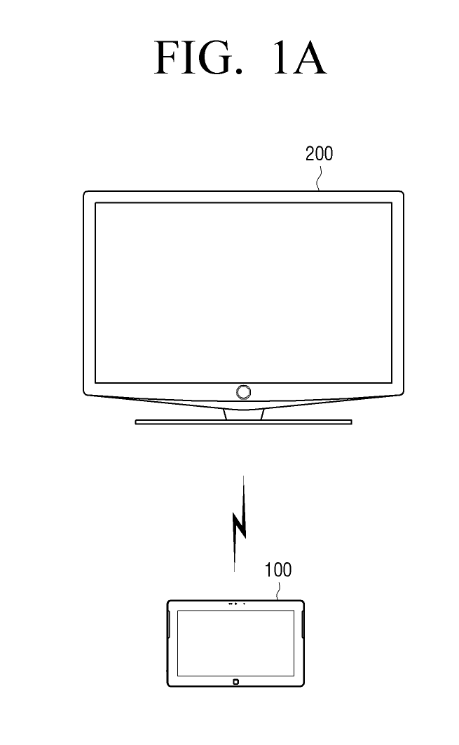

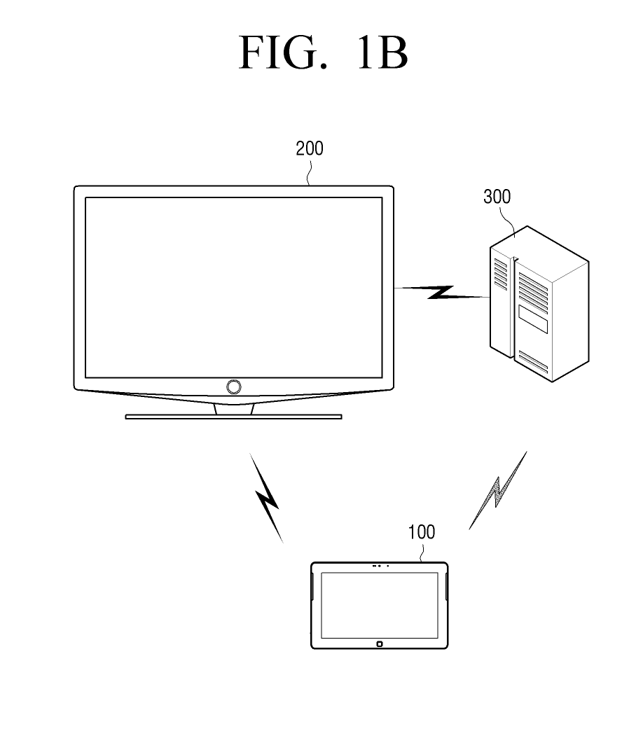

FIG. 1A is a view to illustrate a display system according to an exemplary embodiment.

Referring to FIG. 1A, the display system according to an exemplary embodiment includes a user terminal apparatus 100 and a display apparatus 200.

The user terminal apparatus 100 may be implemented by using a tablet as shown in FIG. 1A, but is not limited to this. The user terminal apparatus 100 may be implemented by using various kinds of electronic devices such as a television (TV), a smart phone, a desktop PC, a laptop, a remote controller, a tablet and the like.

In addition, the user terminal apparatus 100 may control the display apparatus 200 when connecting to the display apparatus 200 via communication. In this case, the user terminal apparatus 100 may provide a UI screen including a variety of information necessary for controlling the display apparatus 200.

In particular, the user terminal apparatus 100 may receive context information of the display apparatus 200 from the display apparatus 200 connected thereto, and control the status of the display apparatus 200 based on the received context information.

In addition, the display apparatus 200 may be implemented by using a digital TV as shown in FIG. 1A, but is not limited to this. The display apparatus 200 may be implemented by using various kinds of devices equipped with a display function, such as a Personal Computer (PC), a navigation device, a kiosk, a Digital Information Display (DID), and the like.

When the display apparatus 200 is implemented by using a digital TV, the display apparatus 200 may be controlled by the user terminal apparatus 100. In this case, the user terminal apparatus 100 may perform a remote control function with respect to the display apparatus 200 when an application providing a remote control mode or a remote control function is driven or executed. That is, the user terminal apparatus 100 may receive a user command to control the display apparatus 200 and transmit a control signal corresponding to the inputted user command to the display apparatus 200. However, this should not be considered as limiting. The user terminal apparatus 100 may be implemented in various forms. For example, the user terminal apparatus may detect a motion or gesture of the user terminal apparatus 100 and transmit a signal corresponding to the motion or the gesture, recognize a voice and transmit a signal corresponding to the recognized voice, or transmit a signal corresponding to an inputted key. In this case, the user terminal apparatus 100 may be implemented to include a motion sensor, a touch sensor, an Optical Joystick (OJ) sensor applying optical technology, a physical button (for example, a tact switch), a display screen, a microphone, etc. in order to receive user commands of various forms. In addition, the user terminal apparatus 100 may be implemented to provide various functions including a calling function, an Internet function, a photographing function, etc., in addition to the remote control function.

The display apparatus 200 may be connected with the user terminal apparatus 100 and receive contents from the user terminal apparatus 100 and reproduce the contents. In particular, the display apparatus 200 may receive contents in a streaming form and reproduce the contents on a real time basis. In addition, the display apparatus 200 may receive a content reproduction signal for driving a program for reproducing contents from the user terminal apparatus 100, and may receive contents from a server 300 and reproduce the contents. In addition, the display apparatus 200 may provide a UI screen including a variety of information according to a user command inputted through the user terminal apparatus 100.

FIG. 1B is a view to illustrate a display system according to an exemplary embodiment.

Referring to FIG. 1B, the display system according to another exemplary embodiment includes a user terminal apparatus 100, a display apparatus 200, and a server 300. The user terminal apparatus 100 and the display apparatus 200 have been described with reference to FIG. 1A, and thus a redundant explanation is omitted.

The server 300 may communicate with the user terminal apparatus 100 and/or the display apparatus 200, and retrieve additional information based on context information of the display apparatus 200 received from the user terminal 100 and provide the additional information to the user terminal apparatus 100. That is, the server 300 may be implemented to additionally retrieve information related to context information of the display apparatus 200 received from the user terminal apparatus 100 based on the context information, and recommend content or provide a predetermined content based on the retrieved additional information. The server 300 may be implemented by using a central server (or an integration server) responsible for interaction between various operating systems and applications in all network systems, or a cloud server using cloud computing technology. Cloud computing refers to Internet-based computing technology, and is a web-based software service which has programs installed in a utility data server over the Internet and calls a program to a computer or a mobile phone as the need arises. A detailed description of the cloud computing is omitted.

Hereinafter, the roles of a user terminal apparatus 100 in a display system according to an exemplary embodiment will be explained in detail with reference to the accompanying drawings.

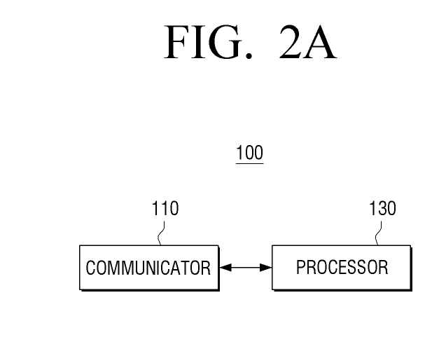

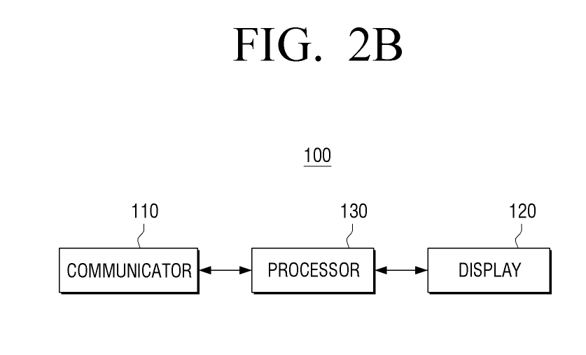

FIG. 2A is a block diagram showing a configuration of a user terminal apparatus according to an exemplary embodiment.

Referring to FIG. 2A, the user terminal apparatus 100 includes a communicator 110 (e.g., a transceiver, etc.) and a processor 130.

The communicator 110 may communicate with an external device according to various communication methods. The external device may include at least one of a display apparatus 200 and a server 300. In particular, the communicator 110 may communicate with the display apparatus (200 in FIG. 1). The communicator 110 may communicate with the display apparatus 200 or the server 300 by using various communication methods such as Bluetooth (BT), Wireless Fidelity (Wi-Fi), Zigbee, Infrared (IR), a serial interface, a Universal Serial Bus (USB), Near Field Communication (NFC), and the like.

Specifically, when a predetermined event occurs, the communicator 110 communicates with the display apparatus 200 in a predetermined communication method to enter an interworking state. The interworking may refer to any state in which it is possible to communicate, such as an operation of initializing communication between the user terminal apparatus 100 and the display apparatus 200, an operation of forming a network, and an operation of performing device pairing. For example, device identification information of the display apparatus 200 may be provided to the user terminal apparatus 100, and accordingly, a pairing procedure may be performed between both the apparatuses. For example, when a predetermined event occurs in the user terminal apparatus 100, the user terminal apparatus 100 may discover a neighboring device through Digital Living Network Alliance (DLNA) technology, and perform pairing with the discovered device to enter the interworking state.

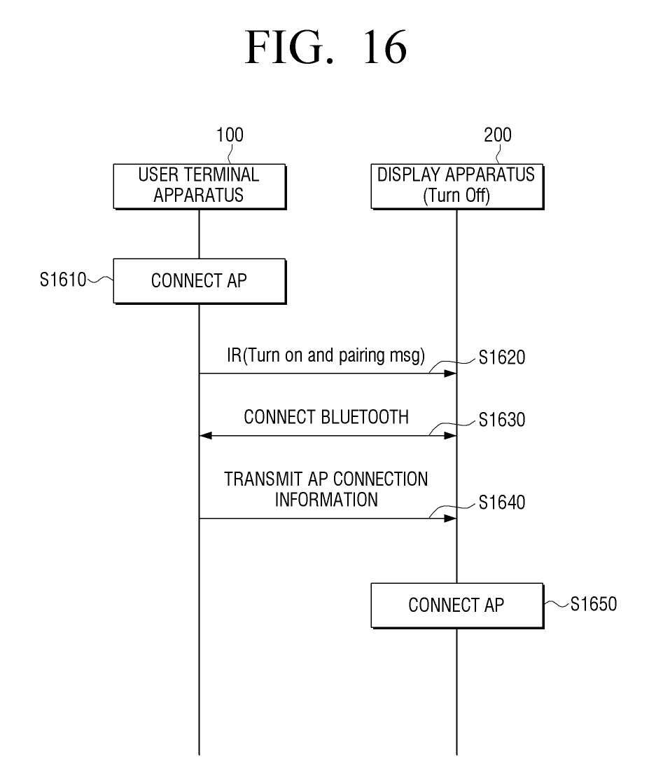

The predetermined event may occur in at least one of the user terminal apparatus 100 and the display apparatus 200. For example, the predetermined event may include an event in which a user command to select the display apparatus 200 as an apparatus to be controlled is inputted to the user terminal apparatus 100, or an event in which the display apparatus 200 is powered on. A pairing method between the user terminal apparatus 100 and the display apparatus 200 according to an exemplary embodiment will be explained in detail below with reference to FIG. 16.

The communicator 110 may receive context information of the display apparatus 200 from the display apparatus 200 while communicating with the display apparatus 200 and the server 300. In addition, the communicator 110 may transmit a signal for controlling the status of the display apparatus 200 or a content reproduction signal to the display apparatus 200, and transmit a content request signal to the server 300.

The processor 130 controls the overall operations of the user terminal apparatus 100.

In particular, the processor 130 may determine whether to receive additional information related to the context information of the display apparatus 200 from the server 300 based on the context information of the display apparatus 200 received from the display apparatus 200, and transmit a signal for controlling the status of the display apparatus 200 based on at least one of the context information and the additional information to the display apparatus 200.

The context information of the display apparatus 200 includes information related to the status of the display apparatus 200, and the processor 130 determines whether to receive additional information related to the context information based on the information related to the status of the display apparatus 200.

Specifically, the context information of the display apparatus 200 may include at least one of information on a content currently displayed on the display apparatus 200, viewing history information, and power status information. The context information may also include information about a user operating the display apparatus 200 (e.g., user profile, user identification, etc.), information on an application currently being executed by the display apparatus 200 (e.g., application name, application status, etc.), information on settings of the display apparatus 200 (e.g., display settings, network settings, etc.), and/or information on technical specifications the display apparatus 200 (e.g., resolution, format, etc.). In addition, the additional information related to the context information of the display apparatus 200 may include at least one of information on a recommended content related to the displayed content, information on a preference based on the viewing history, and information on a display mode based on the power status. The additional information may also include preference information such as a genre of content, an artist, an actor or actress, a director, a title of content, and/or a type of content.

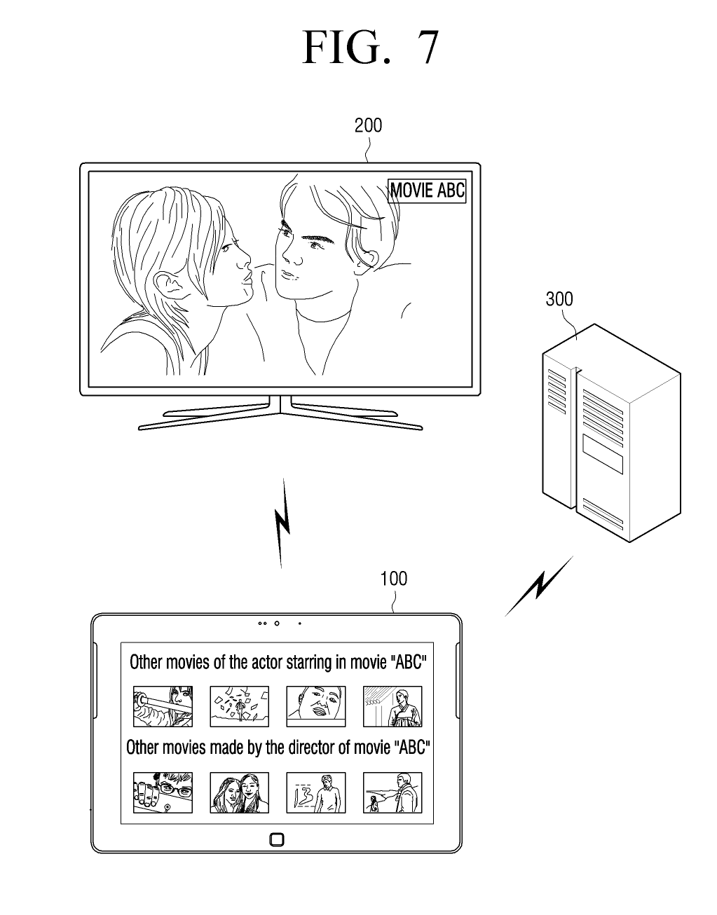

For example, when the information on the content currently displayed on the display apparatus 200 includes information on “drama CC” aired on broadcasting station ABC, the processor 130 may determine whether to receive additional information, such as information on other dramas on ABC and other dramas or movies of the actor starring in drama “CC”, from the server 300. The context information and the additional information will be explained in detail below with reference to FIGS. 7 to 9.

In addition, the processor 130 may transmit a signal for controlling the status of the display apparatus 200 based on at least one of the context information and the additional information to the display apparatus 200.

That is, the processor 130 may transmit a signal for controlling the status of the display apparatus 200 based on only the context information received from the display apparatus 200 to the display apparatus 200, or may transmit a signal for controlling the status of the display apparatus 200 based on both the context information received from the display apparatus 200 and the additional information received from the server 300 to the display apparatus 200.

When the additional information related to the context information received from the display apparatus 200 is already stored in the user terminal apparatus 100, the processor 130 may transmit the stored additional information to the display apparatus 200 without having to receive additional information from the server 300.

For example, when the context information of the display apparatus 200 includes information on a current power status, the processor 130 may transmit a signal for controlling the status of the display apparatus 200, such as a signal for reducing screen brightness of the display apparatus 200 or a signal for terminating a unused program, to the display apparatus 200, without having to receive additional information related to the power status of the display apparatus 200 from the server 300.

In response to the additional information being received from the server 300, the processor 130 may transmit a content reproduction signal for reproducing a predetermined content on the display apparatus based on the additional information and the context information to the display apparatus 200.

The content reproduction signal for reproducing the predetermined content is a kind of signal for controlling the status of the display apparatus 200, and specifically, refers to a content reproduction signal for reproducing a content recommended based on the additional information and the context information.

In addition, the content reproduction signal refers not to a signal for directly transmitting a content to be reproduced, but to a signal for driving an application program necessary for reproducing content.

That is, when the content is related to a movie, the content reproduction signal may be a signal for driving an application program optimized to reproduce a movie, and, when the content is related to music, the content reproduction signal may be a signal for driving a music application program necessary for reproducing music. The optimization for the movie may be a bit-rate optimization, a frame rate optimization, and/or a display resolution optimization etc. The optimization for music may be a bit-rate optimization and/or an equalization optimization, etc.

In addition, the processor 130 may transmit a content request signal for transmitting a predetermined content from the server 300 to the display apparatus 200 based on the received additional information to the server 300.

The content request signal refers to a signal for directly transmitting content from the server 300 to the display apparatus 200. That is, the processor 130 of the user terminal apparatus 100 may transmit the content request signal for allowing the server 300 to transmit content to the display apparatus 200 to the server 300, and the server 300 may transmit the predetermined content to the display apparatus 200 in response to the request of the user terminal apparatus 100.

In addition, the content request signal may include connection information for communicating with the display apparatus 200. Accordingly, the server 300 may exactly determine the display apparatus 200 that the server 300 should transmit the content to, based on the connection information for communicating with the display apparatus 200 included in the received content request signal.

The connection information may include a Media Access Control (MAC) address on a network of the display apparatus 200 or a serial number of the display apparatus 200, thereby providing the server 300 with information on the display apparatus 200 to be connected.

The user terminal apparatus 100 may further include a display and display the predetermined content provided based on at least one of the context information of the display apparatus 200 and the additional information related to the context information through the display in order for the user to easily view it.

FIG. 2B is a block diagram showing a configuration of a user terminal apparatus according to another exemplary embodiment.

Referring to FIG. 2B, the user terminal apparatus 100 includes a communicator 110, a display 120, and a processor 130.

The communicator 110 and the processor 130 have been described in detail with reference to FIG. 2A and thus a redundant explanation is omitted.

The display 120 displays various screens. The screen may include a reproduction screen of various contents such as an image, a moving image, a text, music, and the like, an application execution screen including various contents, a web browser screen, a Graphic User Interface (GUI) screen, and the like.

In this case, the display 120 may be implemented by using a Liquid Crystal Display (LCD) panel, an Organic Light Emitting Diode (OLED), or the like, but is not limited to these. In addition, the display 120 may be implemented by using a flexible display, a transparent display or the like in some cases.

In particular, the processor 130 may display a user interface screen including at least one content through the display 120 based on received additional information.

For example, the processor 130 may receive, from the server 300, additional information related to other moving images of the actor starring in “movie CC” in relation to “movie CC” currently displayed on the display apparatus 200, and provide other moving images of the actor starring in “movie CC” through the display 120.

In this case, the processor 130 may provide other moving images of the actor starring in “movie CC” in the form of thumbnails, and provide a user interface screen including the thumbnails through the display 120, so that the user can easily browse other contents related to the movie currently shown on the display apparatus 200.

The contents displayed on the display 110 may include various kinds of contents.

Specifically, the displayed contents may include various application contents, such as a broadcast content provided in a broadcast viewing mode, a Video On Demand (VOD) content provided in a content reproduction mode, a web page content provided in a web mode, an application program or widget, and a game content. For example, this may correspond to a case in which the user reproduces a specific web moving image content through a web page.

In addition, the displayed contents may include EPG information, text information, thumbnail information, or the like in addition to a real broadcast or a reproduced content. For example, thumbnail information provided on a UI screen to select VOD content may be included in the displayed contents.

The user may select at least one content included in the user interface screen provided through the display 120. In this case, the user terminal apparatus 100 may transmit control signals for reproducing the selected content in the display apparatus 200 to the display apparatus 200 and the server 300, respectively.

Specifically, the processor 130 may transmit, to the display apparatus 200, a content reproduction signal corresponding to the content selected by a user manipulation from the at least one content displayed on the user interface screen, and may transmit, to the server 300, a content request signal for transmitting the selected content from the server 300 to the display apparatus 200.

That is, the user selects one content from at least one content included in the user interface screen displayed on the display 120. On the assumption that the selected content is music, the processor 130 transmits a content reproduction signal for driving an application program for reproducing music to the display apparatus 200. In addition, the processor 130 may transmit a content request signal for transmitting the selected music content from the server 300 to the display apparatus 200 to the server 300.

The content request signal may include connection information for communicating with the display apparatus 200, and the server 300 may determine the display apparatus 200 that the server 300 should transmit the music content to, based on the connection information.

In addition, the user selects one content from at least one content included in the user interface screen displayed on the display 120. On the assumption that the selected content is a movie, the processor 130 transmits a content reproduction signal for driving an application program for reproducing a movie to the display apparatus 200. In addition, the processor 130 may transmit a content request signal for transmitting the selected movie content from the server 300 to the display apparatus 200 to the server 300.

In response to the content reproduction signal received from the user terminal apparatus 100 being received, the display apparatus 200 may determine what kind of content should be reproduced and what kind of application program should be driven, and prepares to execute the determined application program.

In addition, in response to the content being received from the server 300, the display apparatus 200 may reproduce the received content through the determined application program.

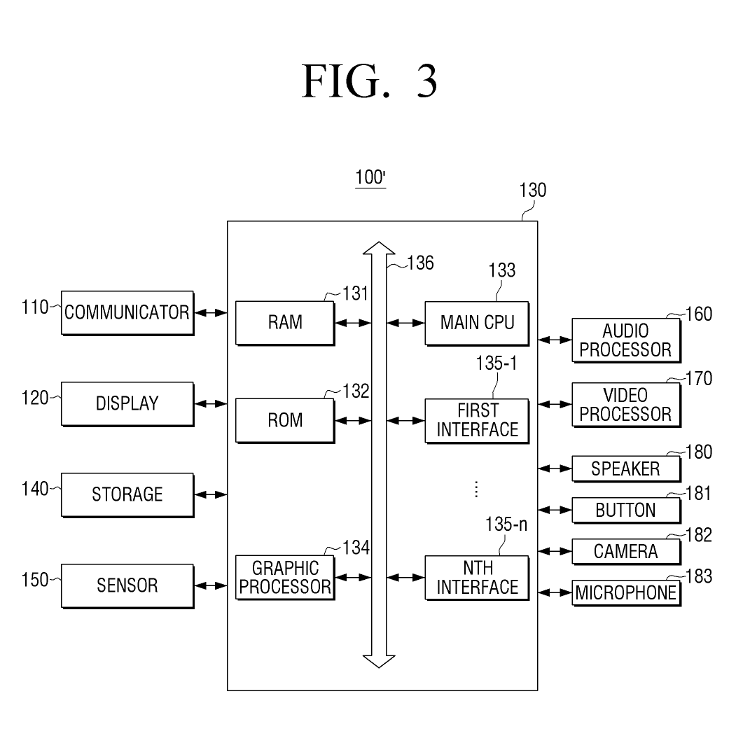

FIG. 3 is a block diagram showing a detailed configuration of a user terminal apparatus 100′ according to another exemplary embodiment. Referring to FIG. 3, the user terminal apparatus 100′ includes a communicator 110, a display 120, a processor 130, a storage 140, a sensor 150, an audio processor 160, a video processor 170, a speaker 180, a button 181, a camera 182, and a microphone 183. The same elements of FIG. 3 as in FIGS. 2A and 2B will not be explained in detail.

In particular, the user terminal apparatus 100 shown in FIG. 3 may be implemented by using a tablet PC, and, when the display apparatus 200 is implemented by using a TV, the detailed configuration of the display apparatus 200 is similar to the configuration shown in FIG. 3.

The processor 130 controls the overall operations of the user terminal apparatus 100 using various programs stored in the storage 140.

Specifically, the processor 130 includes a Random Access Memory (RAM) 131, a Read Only Memory (ROM) 132, a main Central Processing Unit (CPU) 133, a graphic processor 134, 1^{st} to nth interfaces 135-1 to 135-n, and a bus 136.

The RAM 131, the ROM 132, the main CPU 133, the graphic processor 134, and the first to nth interfaces 135-1 to 135-n may be connected to one another via the bus 136.

The 1^{st} to nth interfaces 135-1 to 135-n are connected to the above-described elements. One of the interfaces may be a network interface which is connected to an external device via a network.

The main CPU 133 accesses the storage 140 and performs booting using an Operating System (0/S) stored in the storage 140. In addition, the main CPU 133 performs various operations using various programs, contents, and data stored in the storage 140.

The ROM 132 stores a set of commands for booting a system. When a turn-on command is inputted and power is supplied, the main CPU 133 copies the 0/S stored in the storage 140 into the RAM 131 according to the command stored in the ROM 132, executes the 0/S and boots the system. When booting is completed, the main CPU 133 copies various application programs stored in the storage 140 into the RAM 131, executes the application programs copied into the RAM 131, and performs various operations.

The graphic processor 134 generates a screen including various objects such as an icon, an image, a text, and the like, using a calculator and a renderer. The calculator calculates attribute values of the objects to be displayed such as coordinate values, shape, size, color, and the like of the objects according to the layout of the screen using a received control command. The renderer generates the screen of various layouts including the objects based on the attribute values calculated by the calculator. The screen generated by the renderer is displayed on a display area of the display 120.

The storage 140 may store various data such as an O/S software module for driving the display apparatus 200, various multimedia contents, various applications, various content which are inputted or set while an application is executed.

In addition, the storage 140 may store context information of the display apparatus 200 received from the display apparatus 200 and additional information related to the context information.

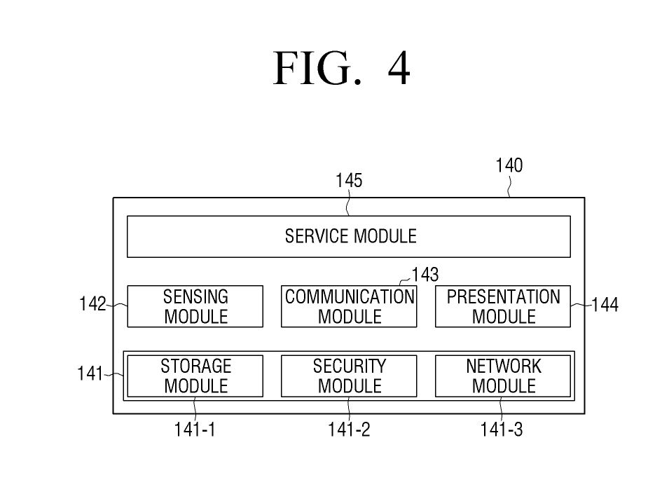

In addition, various software modules stored in the storage 140 will be explained with reference to FIG. 4.

Referring to FIG. 4, the storage 140 may store software including a base module 141, a sensing module 142, a communication module 143, a presentation module 144, and a service module 145.

The based module 141 is a module that processes signals transmitted from each hardware element included in the user terminal apparatus 100′, and transmits the signals to an upper layer module. The base module 141 includes a storage module 141-1, a security module 141-2, and a network module 141-3. The storage module 141-1 is a program module that manages a database (DB) or a registry. The main CPU 133 may access the database in the storage 140 using the storage module 141-1, and read out various data. The security module 141-2 is a program module that supports certification for hardware, permission of a request, and a secure storage, and the network module 141-3 is a module for supporting network connection and includes a Distributed.net (DNET) module and a Universal Plug and Play (UPnP) module.

The sensing module 142 is a module that collects information from various sensors, and analyzes and manages the collected information. The sensing module 142 may include a touch recognition module, a head direction recognition module, a face recognition module, a voice recognition module, a motion recognition module, an NFC recognition module, and the like.

The communication module 143 is a module to communicate with an external device. The communication module 143 may include a device module which is used to communicate with an external device, a messaging module such as a messenger program, a Short Message Service (SMS) and Multimedia Message Service (MMS) program, and an email program, etc., and a telephony module which includes a call information aggregator program module and a Voice over Internet Protocol (VoIP) module.

In addition, the processor 130 may determine whether to receive additional information based on context information of the display apparatus 200 received through the communication module 143, and generate a signal for controlling the status of the display apparatus 200 based on at least one of the context information and the additional information.

The presentation module 144 is a module that generates a display screen. The presentation module 144 includes a multimedia module to reproduce and output multimedia contents, and a UI rendering module to process a UI and graphics. The multimedia module may include a player module, a camcorder module, and a sound processing module. Accordingly, the multimedia module generates a screen and a sound by reproducing various multimedia contents, and reproduces the same. The UI rendering module may include an image compositor module to combine images, a coordinate combination module to combine coordinates on a screen to display an image and generate coordinates, an X11 module to receive various events from hardware, and a 2D/3D UI toolkit to provide a tool for configuring a UI of a 2D or 3D format.

The service module 145 is a module that includes various applications for providing various services. Specifically, the service module 145 may include various program modules such as an SNS program, a content playback program, a game program, an e-book program, a calendar program, a notice management program, and other widgets.

The sensor 150 functions to sense a user's viewing manner.

Specifically, the sensor 150 may be implemented to include a photographer to photograph a user and a detector to detect a user's viewing manner based on an image photographed by the photographer.

The photographer is disposed on a border area of the screen. For example, the photographer may be disposed on a bezel area of an upper center, a left center or a right center of the screen, but is not limited to these. The photographer photographs a user, particularly, a user's face. The photographer includes a lens module including a lens and an image sensor. A shape inputted through the lens is inputted to an image sensor serving as a film as an optical signal, and the image sensor converts the inputted optical signal into an electric signal and transmits the electric signal to a gaze detector. For example, the photographer may be implemented by using a general camera, a stereo camera, a depth camera, or the like.

The detector detects a user's viewing manner. Specifically, the detector may detect an area at which the user gazes and a time during which user's gaze is held by tracing a user's face direction, a user's eyeball movement, and the like. In addition, the detector may detect a variety of visual information indicating preference for a displayed content, such as a user's smiling point of time, an uttered exclamation, a mouth shape, and the like.

Specifically, the detector may identify an eyeball image from a user image photographed by the photographer through a face modeling technique. In this case, the face modeling technique is an analysis process of converting a face image acquired by the photographer into digital information for processing and transmitting, and may use one of an Active Shape Modeling (ASM) technique and an Active Appearance Modeling (AAM) technique. In addition, the detector may determine an eyeball movement using the identified eyeball image. In addition, the detector may detect a user's gazing direction using the eyeball movement and determine a user's gazing area by comparing the user's gazing direction and pre-stored coordinates information of a display screen.

In this case, the processor 130 may generate user preference information based on the user's viewing pattern detected through the detector 150 and attributes of the displayed content, and determine or recommend a predetermined content based on the preference information. This will be explained in detail below.

As described above with reference to FIG. 1B, the display system according to an exemplary embodiment includes the user terminal apparatus 100, the display apparatus 200, and the server 300, and the user terminal apparatus 100 controls the display apparatus 200 and the server 300 communicates with at least one of the user terminal apparatus 100 and the display apparatus 200.

The user terminal apparatus 100 determines whether to receive additional information related to context information from the server based on the context information of the display apparatus 200 received from the display apparatus 200, and transmit a signal for controlling the status of the display apparatus 200 based on at least one of the context information and the additional information to the display apparatus 200.

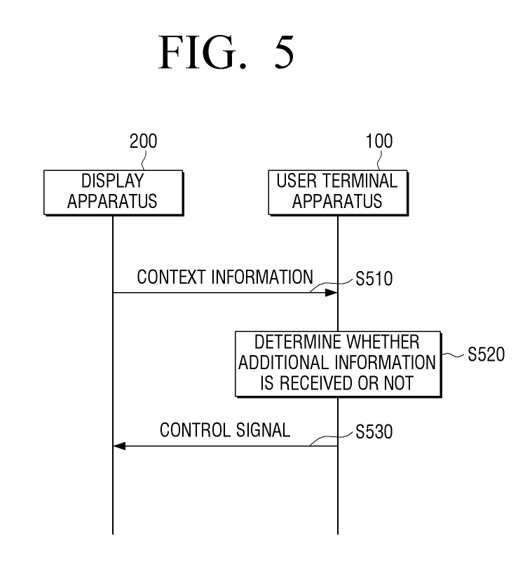

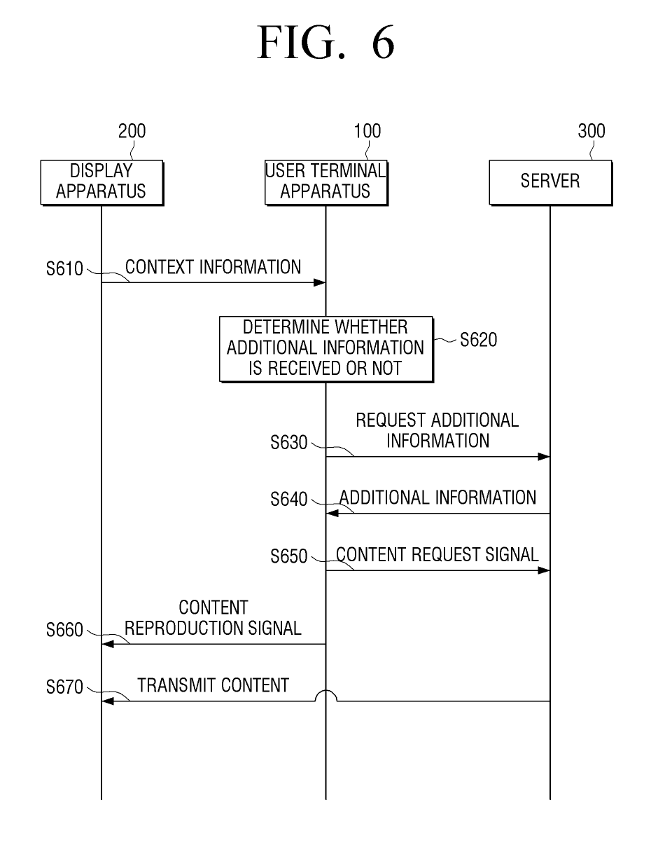

FIGS. 5 and 6 are flowcharts showing information exchange in a system according to an exemplary embodiment.

FIG. 5 illustrates a case in which the user terminal apparatus 100 determines not to receive additional information. Referring to FIG. 5, the user terminal apparatus 100 receives context information from the display apparatus 200 (operation S510), and determines whether to receive additional information related to the context information based on the received context information (operation S520).

For example, when the context information is related to a communication connection status of the display apparatus 200 and indicates an unstable communication connection status of the display apparatus 200, the user terminal apparatus 100 may transmit a control signal including a connection address regarding a new Access Point (AP) or a communication reconnection command to the display apparatus 200 without having to request additional information from the server 300 (operation S530).

In addition, the display apparatus 200 may perform a corresponding function based on the control signal received from the user terminal apparatus 100. For example, the display apparatus 200 may connect to the connection address of the new AP.

FIG. 6 illustrates a case in which the user terminal apparatus 100 determines to receive additional information. Referring to FIG. 6, the user terminal apparatus 100 receives context information from the display apparatus 200 (operation S610), and determines whether to receive additional information related to the context information based on the received context information (operation S620).

In response to determining to receive the additional information, the user terminal apparatus 100 requests the additional information from the server 300 (operation S630). In response to the additional information being received (operation S640), the user terminal apparatus 100 transmits a content request signal for transmitting a content from the server 300 to the display apparatus 200 to the server 300 (operation S650).

The user terminal apparatus 100 transmits, to the display apparatus 200, a content reproduction signal for reproducing a predetermined content in the display apparatus 200 based on the additional information and the context information (operation S660).

The server 300 transmits a content corresponding to the received content request signal to the display apparatus 200 (operation S670).

The display apparatus 200 drives an application program for reproducing the content based on the received content reproduction signal, and displays the content received from the server 300. For example, the display apparatus may display a movie that is requested by the user terminal apparatus based on the context information. The move may be received directly from the server.

The content request signal used in the display system described above includes connection information for communicating with the display apparatus 200.

FIGS. 7 to 9 are views showing additional information received for each piece of context information according to various exemplary embodiments.

Referring to FIG. 7, the display apparatus 200 currently displays “movie ABC”, and the user terminal apparatus 100 receives information on currently displayed “movie ABC” from the display apparatus 200.

The information on “movie ABC” may include information on an actor starring in “movie ABC,” information on a director of “movie ABC,” information on a synopsis, and information on a replay time, and the processor 130 of the user terminal apparatus 100 may request additional information from the server 300 based on the above-described information.

The server 300 may retrieve relevant additional information from a DB based on the information on the director of “movie ABC,” the information on the synopsis, the information on the replay time from among the information on “movie ABC” received from the user terminal apparatus 100, and transmit the retrieved additional information to the user terminal apparatus 100.

The user terminal apparatus 100 may display a user interface screen including various contents based on the information on “movie ABC” and the additional information.

In FIG. 7, other movies of the actor starring in “movie ABC” and other movies made by the director of “movie ABC” are displayed on the display 120 of the user display apparatus 100 in the form of thumbnails. However, this should not be considered as limiting and the synopsis regarding the movie or the replay time may also be displayed, and a variety of information may be displayed in addition to the above-described information. For example, movies that are related in genre or movies that are viewed by users that have viewed “movie ABC” may be provided.

In response to the user selecting one of the other movies of the actor starring in “movie ABC,” the user terminal apparatus 100 transmits a content reproduction signal for driving an application program for reproducing the selected movie to the display apparatus 200, and transmits a content request signal for transmitting the selected movie file from the server 300 to the display apparatus 200 to the server 300.

Accordingly, the display apparatus 200 drives the application program for reproducing the movie and receives the movie file from the server 300 and reproduces the movie file.

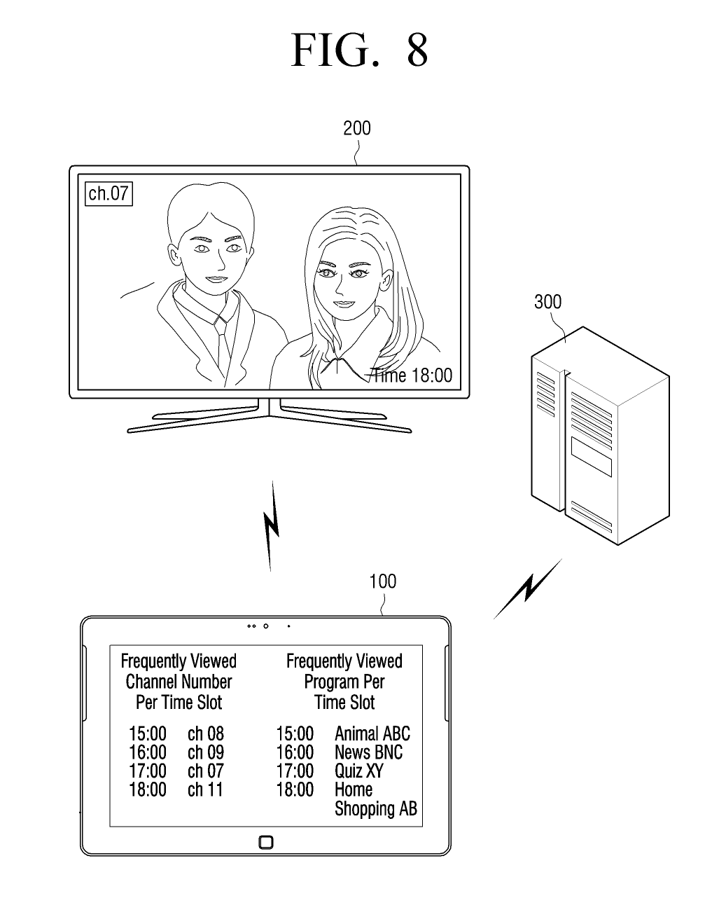

Referring to FIG. 8, the display apparatus 200 transmits information on a viewing history to the user terminal apparatus 100. The information on the viewing history is stored in the storage 140 of the user terminal apparatus 100, so that the processor 130 can determine the user's viewing history and determine preference based on the viewing history.

The information on the viewing history may include information on a current time and a current channel. In the case of FIG. 8, the display apparatus 200 transmits information indicating the current time and information indicating that the currently selected channel is channel 7 to the user terminal apparatus 100.

In addition, the user terminal apparatus 100 transmits the information on the viewing history to the server 300, and the server 300 updates preference by comparing the received information on the viewing history and existing information on the viewing history and transmits information on a recommended content or a recommended channel number according to the preference to the user terminal apparatus 100. The server may also transmit information on related content to related channel numbers.

The user terminal apparatus 100 may display a user interface screen including a variety of information based on the information on the preference.

In FIG. 8, a channel number frequently viewed per time slot and a program frequently viewed per time slot are displayed on the display 120 of the user display apparatus 100 based on the information on the preference. However, this should not be considered as limiting.

In response to the user selecting channel number 11 which is a frequently viewed channel number at the present time from among the channel numbers frequently viewed per time slot, the processor 130 generates a control signal to change the channel number of the display apparatus 200 to number 11 and transmits the control signal to the display apparatus 200.

That is, unlike in the example of FIG. 7, the processor 130 generates a signal to change the channel number of the display apparatus 200 and transmits the signal to the display apparatus 200, without having to transmit a content reproduction signal to the display apparatus 200 and transmit a content request signal to the sever 300.

The display apparatus 200 changes the channel number to 11 and provide the changed channel based on the channel change signal received from the user terminal apparatus 100.

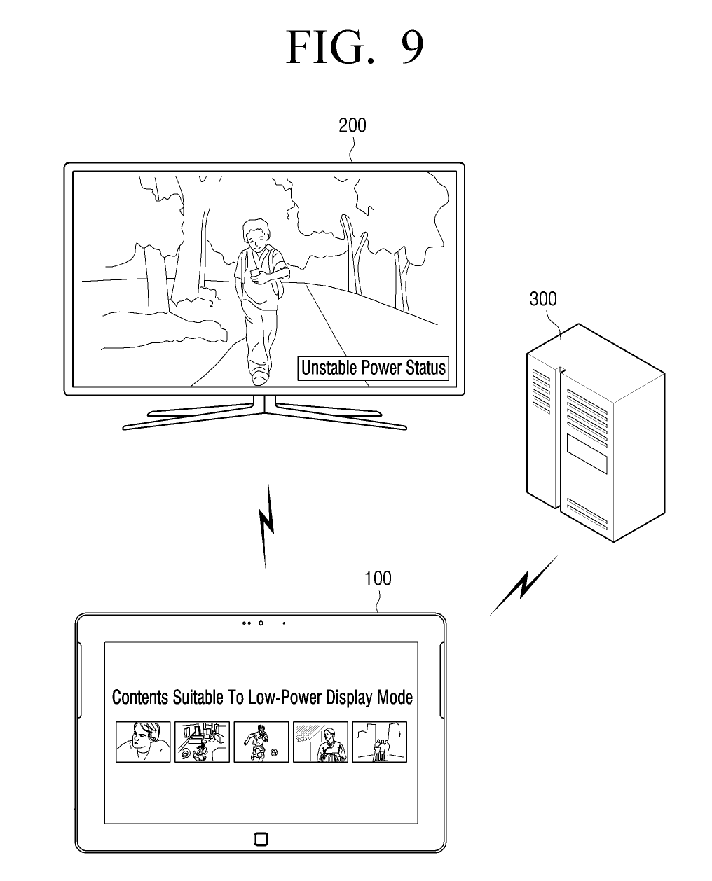

Referring to FIG. 9, when the power status of the display apparatus 200 is unstable while the display apparatus 200 displays an image, power status information may be transmitted to the user terminal apparatus 100.

The power status information may include information on whether the power status of the display apparatus 200 is good or poor or information on how long the display apparatus 200 can be operated with currently remaining power. The power status information may indicate the remaining power in capacity or time until the remaining power is expended.

In addition, the user terminal apparatus 100 may determine whether to receive additional information or not based on the power status information.

First, in response to determining that the power status of the display apparatus 200 is unstable, the user terminal apparatus 100 transmits a control signal to reduce brightness of the display 120 of the display apparatus 200 or change a reproduction mode of the display apparatus 200 to a low-power mode to the display apparatus 200, without having to receive the additional information from the server 300, so that the display apparatus 200 can maintain its status appropriately according to the power status.

In response to the user terminal apparatus 100 requesting the additional information from the server 300 based on the power status information of the display apparatus 200, the server 300 may search for a content suitable for the low-power display mode from the DB based on the power status of the display apparatus 200 received from the user terminal apparatus 100.

For example, the server 300 may search for a content containing many dark images which can maintain low screen brightness suitable for the low-power display mode, or a content which has a short replay time. In addition, the server 300 may transmit information on the result of the retrieving to the user terminal apparatus 100.

The user terminal apparatus 100 may display a user interface screen including various contents based on the content containing many dark images which can maintain low screen brightness, or the content which has a short replay time. For example, the replay time may be a time that is less than or equal to the time that the remaining power is able power the display apparatus or user terminal apparatus.

In FIG. 9, a plurality of contents suitable for the low-power display mode are displayed on the display 120 of the user terminal apparatus 100 in the form of thumbnails. However, this should not be considered as limiting.

In addition, in response to the user selecting one of the plurality of contents suitable for the low-power display mode, the user terminal apparatus 100 transmits a content reproduction signal to drive an application program for reproducing the selected content to the display apparatus 200, and transmits a content request signal to transmit the selected content file from the server 300 to the display apparatus 200 to the server 300. The selected content may be an image, a video, or music.

Accordingly, the display apparatus 200 drives the application program for reproducing the selected content and also receives the content suitable for the low power mode from the server 300 and reproduces the content, so that the display apparatus 200 can be operated with low power.

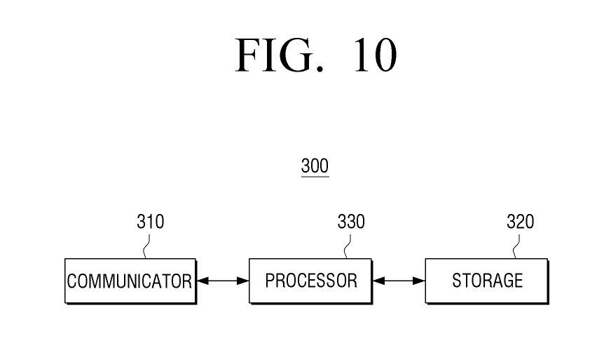

FIG. 10 is a block diagram showing a configuration of a server according to an exemplary embodiment of the present disclosure.

Referring to FIG. 10, the server 300 includes a communicator 310, a storage 320, and a processor 330.

According to the exemplary embodiment shown in FIG. 1B, the server 300 may communicate with at least one of the user terminal apparatus 100 and the display apparatus 200, and retrieve additional information based on context information of the display apparatus 200 received from the user terminal apparatus 100 and transmit the retrieved additional information to the user terminal apparatus 100.

The server 300 may transmit a content corresponding to a content request signal received from the user terminal apparatus 100 to the display apparatus 200. Because the content request signal includes connection information for communicating with the display apparatus 200, the server 300 may exactly determine the display apparatus 200 that the server 300 should transmit the content based on the connection information.

In addition, the server 300 communicates with the user terminal apparatus 100 and receives information on user activity performed in the user terminal apparatus 100. The server 300 may generate user preference information based on the information on the user activity and a content displayed on the display apparatus 200, and transmit information on a recommended content to the display apparatus 200 based on the preference information.

The server 300 may determine whether the information on the user activity has a positive relation or a negative relation to the displayed content, and generate user preference information based on the determined relation.

The communicator 310 communicates with at least one of the user terminal apparatus 100 and the display apparatus 200.

Specifically, the communicator 310 may receive, from the user terminal apparatus 100, information on the content displayed on the display apparatus 200 and information on the user activity occurring in the user terminal apparatus 100, and provide information on a recommended content to the display apparatus 200 and/or the user terminal apparatus 100.

The storage 320 stores information received from the display apparatus 200 and/or the user terminal apparatus 100, user preference information determined based on corresponding information, and recommended content information generated based on the user preference information. In addition, the storage 320 updates the stored information when receiving new information and store the updated information.

In addition, in response to a corresponding service being provided according to user authentication, the storage 320 may store a variety of user information such as sex, age, hobby, etc. of the user.

In addition, the storage 320 may store profile information of another user which is a buddy of the user, and activity information of another user received from a user terminal apparatus of another user, preference information of another user generated based on corresponding activity information, and the like. The storage 320 may also store profile information of other users, which are not buddies of the user, but that may have a user profile information in common with the user, and preference information of the user may be determined partially based on the preference information of the other user.

The processor 330 controls the overall operations of the server 300. The processor 330 is similar to the detailed configuration of the processor 130 shown in FIG. 2B, and a detailed description thereof is omitted.

The processor 330 may generate user preference information based on content information received from the display apparatus 200 and user activity information received from the user terminal apparatus 100, and recommend a content based on the generated user preference information. Specifically, the processor 330 may transmit recommended content information to the display apparatus 200 and/or the user terminal apparatus 100.

The processor 330 may recommend content based on preference information of another user who has a predetermined buddy relationship with the user of the user terminal apparatus 100. For example, the processor 330 may generate preference information of another user based on activity information received from a user terminal apparatus of another user, and transmit recommended content information according to the preference information of another user to the display apparatus 200 and/or the user terminal apparatus 100.

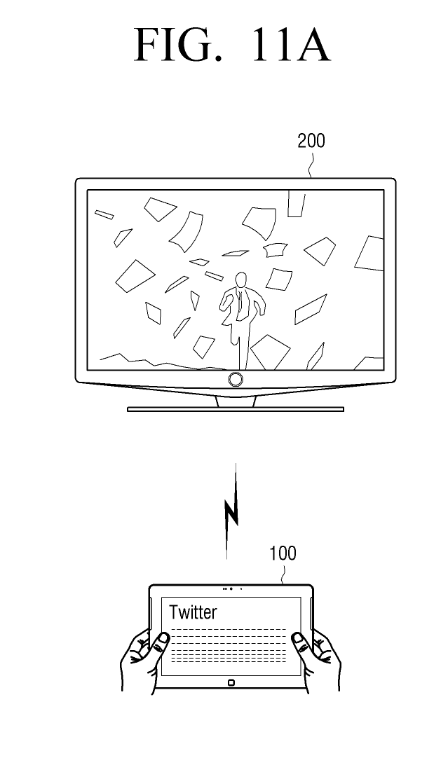

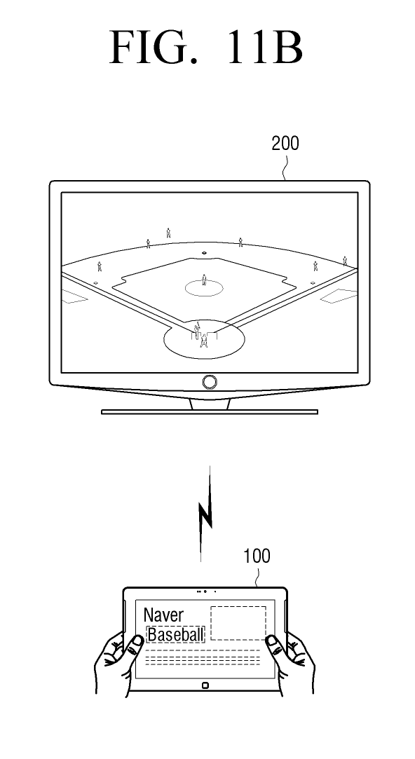

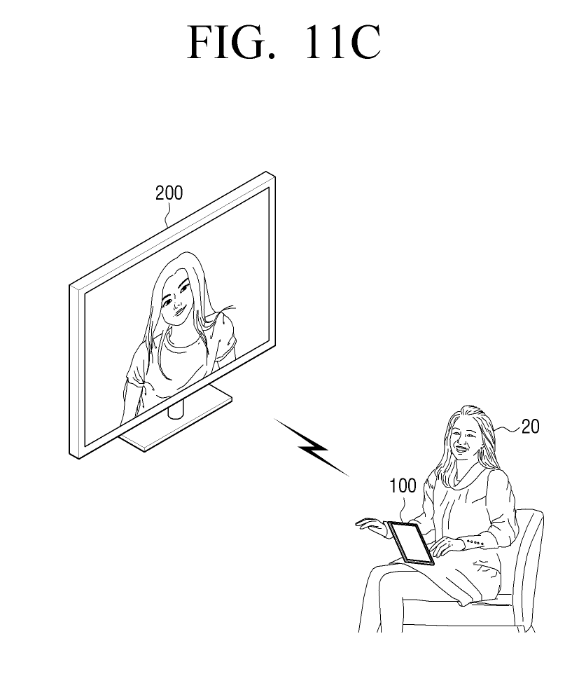

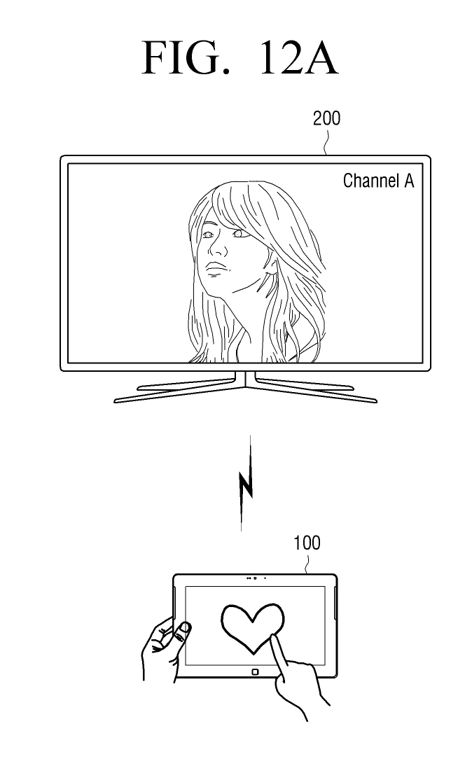

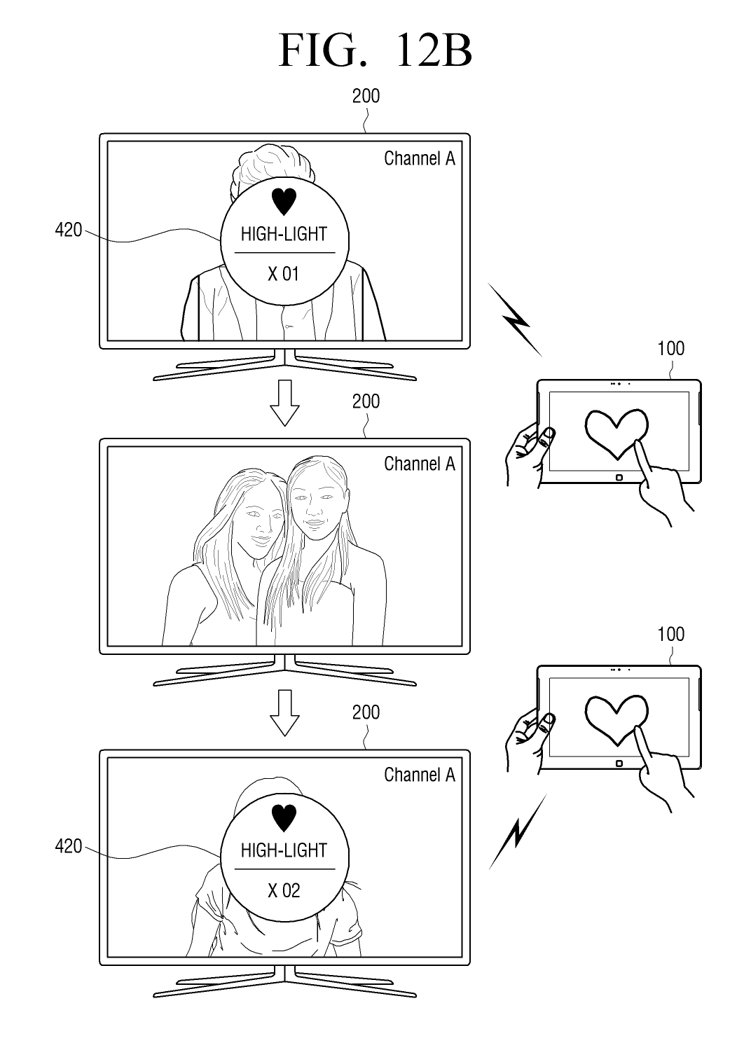

FIGS. 11A to 11C and 12A and 12B are views to illustrate a user activity type according to various exemplary embodiments.

As shown in FIG. 11A, user activity in the user terminal apparatus 100 may be activity for a social networking service (SNS). For example, the user activity for a displayed content may include various type of activities performed on an SNS, such as writing a comment on a real time like on Twitter, capturing a corresponding content scene and uploading the scene onto an SNS server, writing a comment for the uploaded content scene, displaying preference by voting, and the like. When the activity for the SNS is related to the displayed content, the corresponding activity generates positive preference information on one of various attributes of the displayed content, and, when the activity for the SNS is not related to the displayed content, the corresponding activity may contribute to generating negative preference information on one of the various attributes of the displayed content or may not influence generating the preference information. For example, the user activity may include a hashtag related to the displayed content that may be used to generate positive preference information about the displayed content.

In addition, the user activity in the user terminal apparatus 100 may be activity related to Internet use as shown in FIG. 11B. For example, the user activity may include various types of activities performed through the Internet, such as surfing the Internet based on a search term related to a displayed content, or surfing the Internet based on a search term having no relation to the displayed content. Such Internet surfing activity may contribute to generating positive or negative preference information according to whether the activity is related to the displayed content or not.

As shown in FIG. 11C, the user activity may be visual information such as a user's gazing time, a smiling point of time, an uttered exclamation, a mouth shape, and etc., rather than activity performed on the user terminal apparatus 100. Further, speech from the conversation of the user may be recognized and the recognized terms may be used to generate preference information.

In addition, as shown in FIGS. 12A and 12B, the user activity may be user interaction for directly displaying preference for at least one of a displayed content, a content attribute, and at least one object included in the content. For example, as shown in FIG. 12A, the user activity may include user interaction to display preference for a displayed content or user interaction to display preference for a scene constituting a content. The user interaction may include a user touch input which draws a heart shape (“ [symbol] ”) on a touch pad of the user terminal apparatus 100 and pressing a predetermined button provided on the user terminal apparatus 100. The user interaction may be pressing an icon or predetermined area of the user terminal apparatus.

However, although not shown, all the activities which can be performed in the user terminal apparatus 100, such as calling, sending a text message, playing a game, and the like may correspond to activity for generating user preference information.

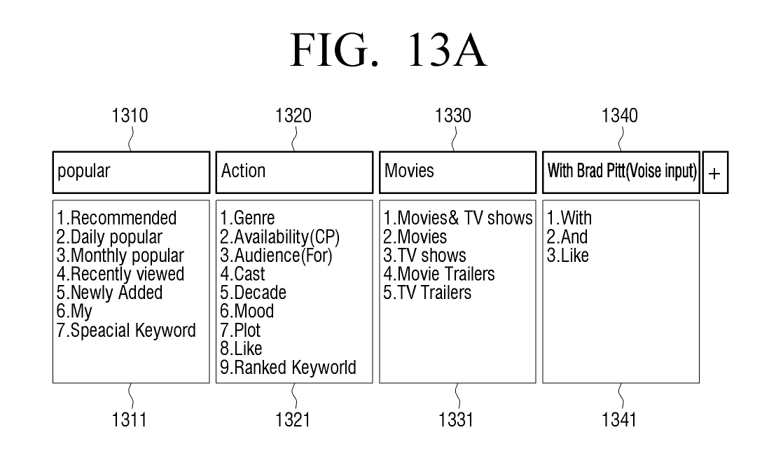

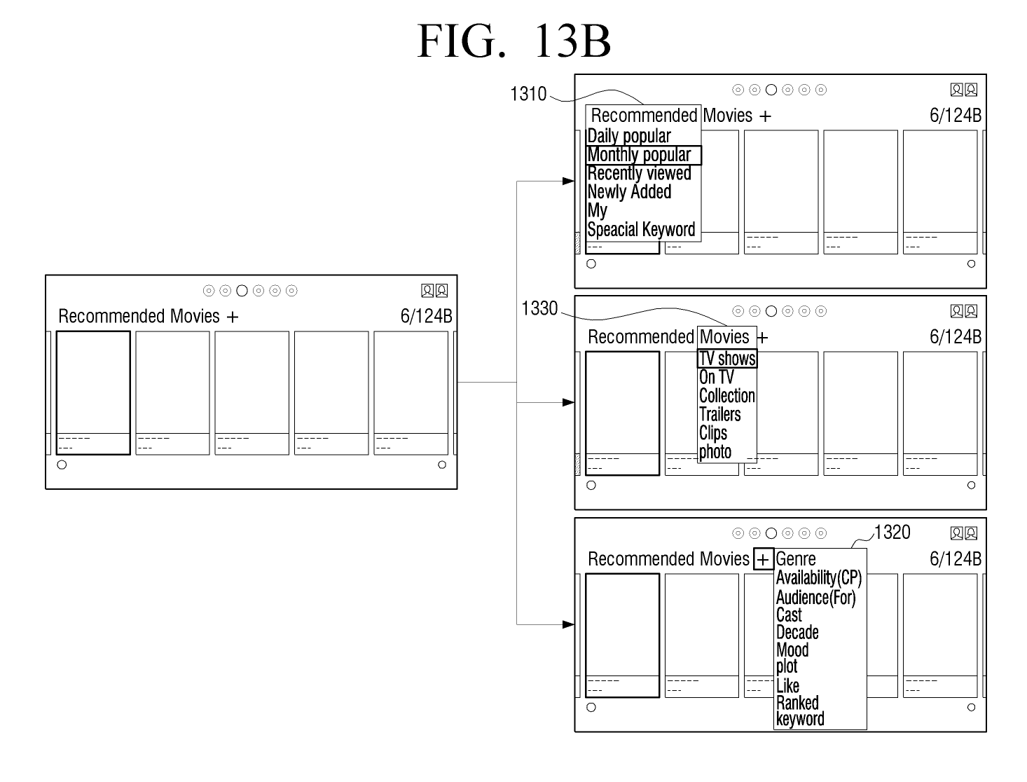

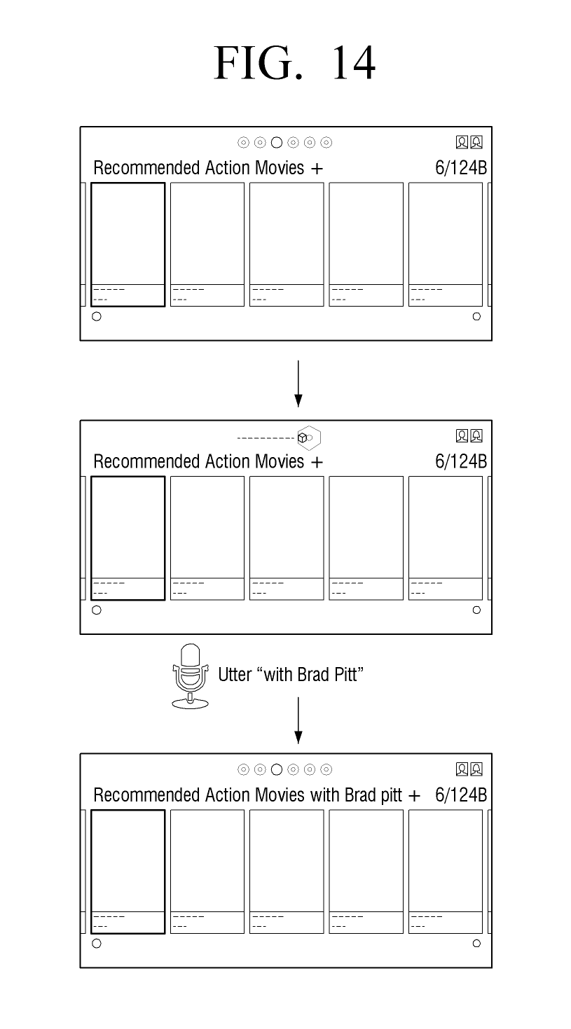

FIGS. 13A and 13B and 14 are views to illustrate a method for searching for a recommended content according to an exemplary embodiment.

According to an exemplary embodiment, to search for a recommended content according to preference information, a content searching method using a filter may be used instead of an existing content searching method.

Specifically, as shown in FIG. 13A, a recommended content may be searched using a relation filter 1310, a content filter 1330, and a sub-type filter 1320, and search term filter 1340.

For example, the relation filter 1310 may allow the user to apply relation filters 1311 based on one or more of recommended content, popular daily content, popular monthly content, recently viewed content, newly added content, or another special keyword that describes the relationship. In addition, the content filter 1330 may allow the user to apply content filters 1331 based on one or more of movies, TV shows, movie trailers, TV trailers, etc. Further, the sub-type filter 1320 may allow the user to apply sub-type filters 1321 that are based on one or more of genre, availability, audience, cast, decade, mood, plot, or other ranked keywords, etc. Further still, the search term filter 1340 may allow the user to apply a search term with a logical command 1341 including “with,” “and” “like,” etc.

FIG. 13B illustrates a case in which “Recommended” is selected as the relation filter 1310, “Movies” is selected as the content filter 1330, and “Genre” is selected as the sub-type filter 1320.

In addition, after a searching condition using filters is completed as shown in FIG. 14, searching may be performed by combining search terms generated by user voices. Specifically, when content is recommended based on user preference information and the user wishes to receive a recommendation by adding details, the user may add a searching condition by uttering a corresponding word. This uttered words may be used with the search term filter 1340.

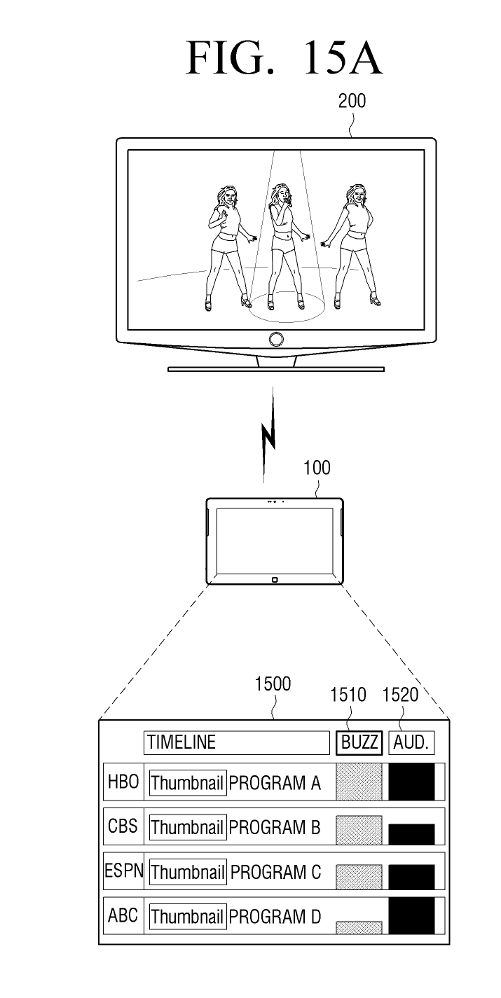

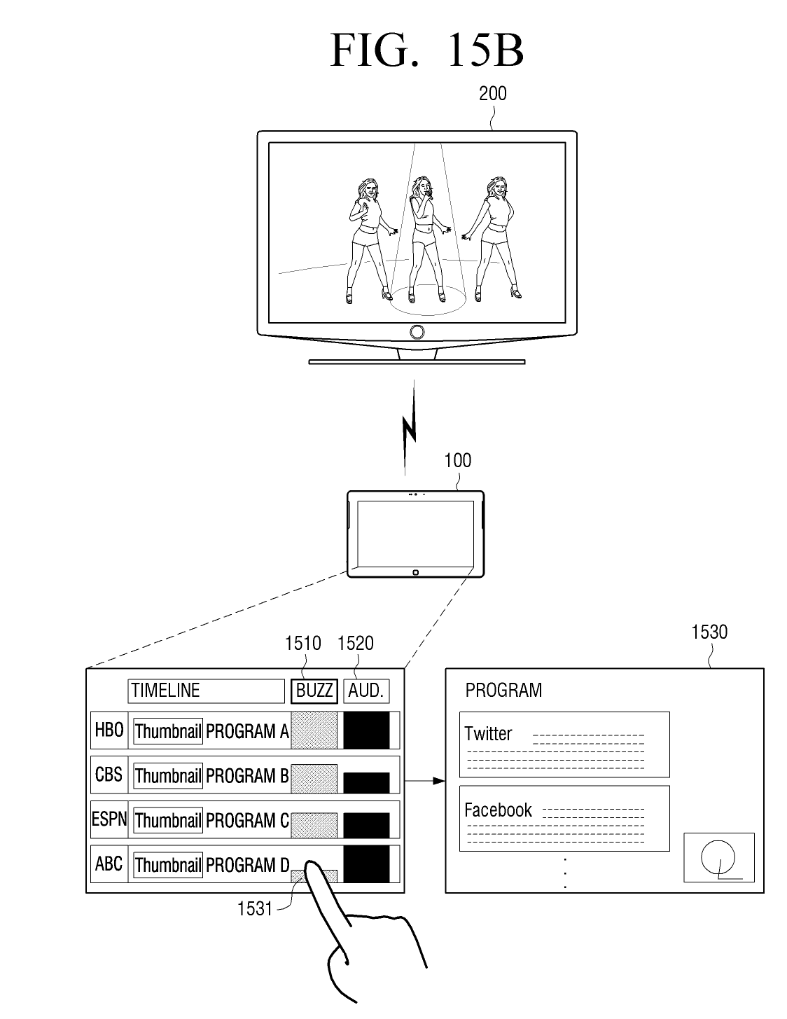

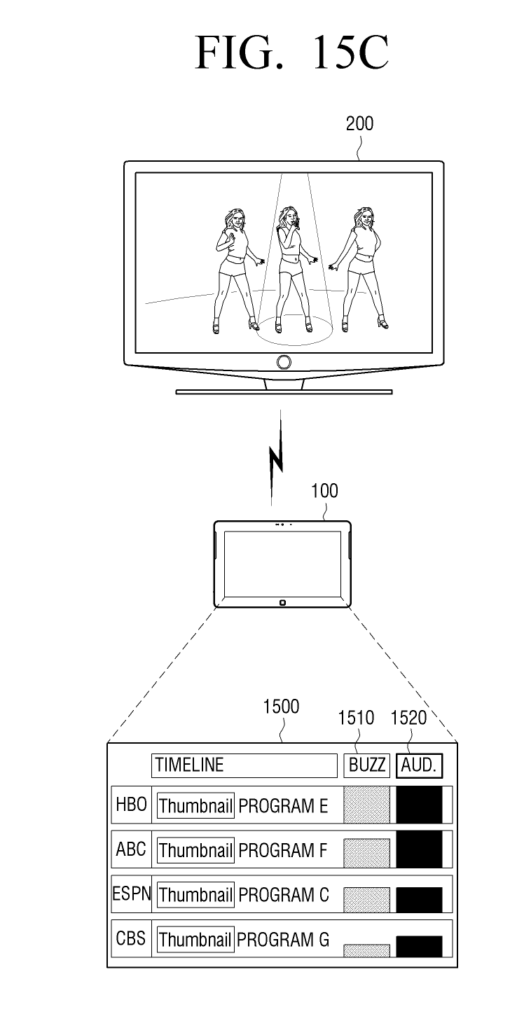

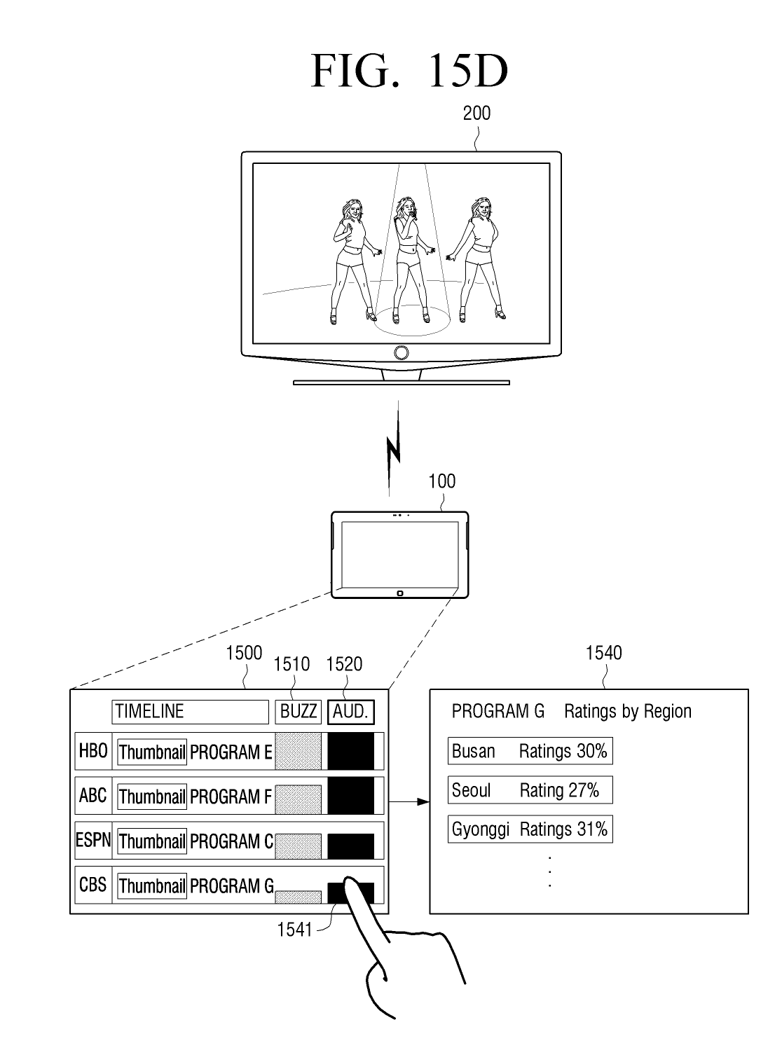

FIGS. 15A to 15D are views to illustrate a method for providing a UI of a user terminal apparatus according to various exemplary embodiments.

As shown in FIG. 15A, an EPG screen 1500 may be provided on the user terminal apparatus 100. In this case, whether the display apparatus 200 is powered on or off has nothing to do with the operation of the user terminal apparatus 100.

In this case, a content list is arranged in order of channel number on the EPG screen, and the EPG screen may be manipulated by a user's touch operation. For example, when the user wishes to know future programming information, the user may move or jump to a desired time by touching and dragging a time line (point and drag).

When the user wishes to identify a broadcast content which is the most likely to be shared in an SNS from among reproducible broadcast contents, a “buzz” filter 1510 may be executed as shown in FIG. 15A. In this case, the contents are arranged on the EPG screen in order of the degree of SNS sharing rather than in order of channel number. In this case, the degree of SNS sharing (hereinafter, referred to as the degree of “buzz”) may be displayed by a simple infographic icon, and the degree of buzz can be easily identified by the user with simple graphics rather than complicated statistical figures.

In response to a buzz icon 1531 being selected by the user as shown in FIG. 15B, detailed contents mentioned in the SNS may be displayed 1530. Accordingly, the user may refer to other users' comments on the corresponding content.

In addition, when the user wishes to identify a broadcast which has the highest rating from among the reproducible broadcast contents, an “Audience” (AUD) filter 1520 may be executed as shown in FIG. 15C. In this case, the contents are arranged on the EPG screen in order of ratings rather than in order of channel number. In this case, the rating is displayed by a simple infographic icon and the rating can be easily identified by the user with simple graphics rather than complicated statistical figures.

In addition, in response to an audience icon 1541 being selected by the user as shown in FIG. 15D, distribution of ratings may be identified. Specifically, the distribution of ratings may be identified according to regions (for example, Seattle), time zones (for example, Eastern Standard), profiles (for example, sex, age), etc.

In addition, although not shown in the drawings, a “genre” filter may be added to the EPG screen in addition to the “buzz” filter or the “AUD” filter. In this case, the contents may be filtered based on a combination of the “buzz” filter or the “AUD” filter and the “genre” filter. For example, when the “buzz” filter and the “genre” filter are combined, the contents may be arranged in order of “news” programs which are the most frequently mentioned contents in the SNS from the current broadcast contents. In another example, when the “AUD” filter and the “genre” filter are combined, the contents may be arranged in order of “reality” programs which have the highest ratings from among the current broadcast contents.

However, the examples shown in FIGS. 15A to 15D are not limited to the broadcast contents and may be equally applied to VOD contents. For example, in response to the “buzz” filter being executed for VOD contents, the contents may be arranged in order of degree of SNS sharing, and, in response to the “AUD” filter being executed, the contents may be arranged in order of content buying rates.

In response to a specific content on the EPG screen of the user display apparatus 100 being selected, the user display apparatus 100 may transmit a content request signal for transmitting the selected content from the server 300 to the display apparatus 200 to the server 300, and transmit a content reproduction signal for the display apparatus 200 to drive an application program for reproducing the selected content to the display apparatus 200.

Accordingly, the display apparatus 200 may execute the selected content.

Accordingly, because the EPG screen is provided with reference to preference of related people such as acquaintances or preference of the public, content suitable for a user's viewing purpose can be recommended and thus the user can view the content more easily and more rapidly.

The user terminal apparatus 100 and the display apparatus 200 should perform pairing prior to communicating with each other and may connect to the same AP during the pairing process.

For example, the user terminal apparatus 100 may initiate the pairing operation with the display apparatus 200 by transmitting a control signal to the display apparatus 200, and, when the pairing is completed, the user terminal apparatus 100 may transmit connection information on the AP to the display apparatus 200, so that the display apparatus 200 can connect to the same AP as the user terminal apparatus 100.

In addition, the user terminal apparatus 100 may add the connection information on the AP or a serial number of the display apparatus 200 to a content request signal, and may transmit the content request signal to the server 300.

FIG. 16 is a timing chart to illustrate a method for connecting to an AP according an exemplary embodiment.

Referring to FIG. 16, the user terminal apparatus 100 connects to an AP 300 via communication (operation S610).

Because the display apparatus 200 is turned off as shown in FIG. 16, the user terminal apparatus 100 transmits an IR signal including a turn-on command and a pairing initiation command to turn on the display apparatus 200 (operation S620).

The display apparatus 200 receives the IR signal including the turn-on command and the pairing initiation command from the user terminal apparatus 100 and thus is turned on, and automatically performs pairing with the user terminal apparatus 100 which has transmitted the IR signal. When the pairing is completed, the display apparatus 200 is connected with the user terminal apparatus 100 via Bluetooth communication (operation S630).

In addition, the user terminal apparatus 100 transmits connection information on the existing AP 300 to the display apparatus 200 via the Bluetooth communication (operation S640).

The display apparatus 200 which receives the connection information on the AP 300 via the Bluetooth communication connects a communication session with the AP 300 based on the connection information of the AP 300 (operation S650).

In FIG. 16, the user terminal apparatus 100 transmits the control signal to the display apparatus 200 via the IR signal and performs Bluetooth communication by performing pairing. However, this should not be considered as limiting. Various one-way wireless communication methods and bidirectional wireless communication methods may be applied.

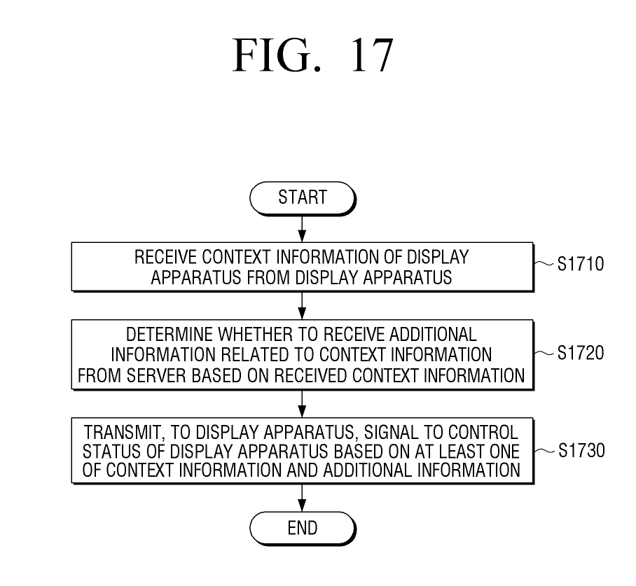

FIG. 17 is a flowchart to illustrate a control method of a user terminal apparatus according to an exemplary embodiment.

According to the control method of the user terminal apparatus shown in FIG. 17, context information of the display apparatus is received from the display apparatus (operation S1710).

It is determined whether additional information related to the context information is received from the server based on the received context information (operation S1720).

A signal for controlling the status of the display apparatus based on at least one of the context information and the additional information is transmitted to the display apparatus (operation S1730).

The transmitting includes, in response to the additional information being received from the server, transmitting a content reproduction signal for reproducing a predetermined content in the display apparatus based on the additional information and the context information to the display apparatus.

The control method of the user terminal apparatus according to an exemplary embodiment may further include transmitting, to the server, a content request signal for transmitting the predetermined content from the server to the display apparatus based on the additional information.

The control method of the user terminal apparatus may further include displaying a user interface screen including at least one content based on the additional information.

The control method of the user terminal apparatus may further include transmitting, to the display apparatus, a content reproduction signal corresponding to a content selected by a user manipulation from at least one content displayed on the user interface screen, and transmitting a content request signal for transmitting the selected content from the server to the display apparatus to the server.

The content request signal may include connection information for communicating with the display apparatus.

In addition, the context information of the display apparatus may include at least one of information on a content currently displayed on the display apparatus, viewing history information, and power status information, and the additional information may include at least one of information on a recommended content related to a displayed content, information on preference based on a viewing history, and information on a display mode based on a power status.

A non-transitory computer readable medium storing a program for performing the control method according to the above-described various exemplary embodiments in sequence may be provided.

For example, a non-transitory computer readable medium storing a program, which receives context information of a display apparatus from the display apparatus, determines whether to receive additional information related to the context information from a server based on the context information, and transmits a signal for controlling the status of the display apparatus based on at least one of the context information and the additional information to the display apparatus, may be provided.

The non-transitory computer readable medium refers to a medium that stores data semi-permanently rather than storing data for a very short time, such as a register, a cache, and a memory, and is readable by an apparatus. Specifically, the above-described various applications or programs may be stored in a non-transitory computer readable medium such as a compact disc (CD), a digital versatile disk (DVD), a hard disk, a Blu-ray disk, a universal serial bus (USB), a memory card, and a read only memory (ROM), and may be provided.

Although a bus is not illustrated in the block diagrams of the user terminal apparatus, the display apparatus, and the server, communication may be performed between the respective elements of the user terminal apparatus, the display apparatus, and the server via the bus. In addition, each apparatus may further include a processor such as a Central Processing Unit (CPU) or a microprocessor to perform the above-described various operations.

The foregoing exemplary embodiments and advantages are merely exemplary and are not to be construed as limiting the present inventive concept. The exemplary embodiments can be readily applied to other types of apparatuses. The description of the exemplary embodiments is intended to be illustrative, and not to limit the scope of the claims, and many alternatives, modifications, and variations will be apparent to those skilled in the art.

What is claimed is:

1. A user terminal apparatus comprising:
a communicator configured to communicate with a display apparatus and a server; and
a processor configured to determine whether to receive additional information from the server based on context information of the display apparatus received from the display apparatus, and to control the communicator to transmit, to the display apparatus, a signal for controlling a status of the display apparatus based on at least one of the context information and the additional information.

2. The user terminal apparatus of claim 1, wherein, in response to the additional information being received from the server, the processor is further configured to control the communicator to transmit, to the display apparatus, a content reproduction signal for reproducing a predetermined content in the display apparatus based on the received additional information and the context information.

3. The user terminal apparatus of claim 2, wherein the processor is further configured to control the communicator to transmit, to the server, a content request signal for transmitting the predetermined content from the server to the display apparatus based on the received additional information.

4. The user terminal apparatus of claim 3, further comprising a display,
wherein the processor is further configured to control the display to display a user interface screen comprising at least one content based on the received additional information.

5. The user terminal apparatus of claim 4, wherein the processor is further configured to control the communicator to transmit, to the display apparatus, a content reproduction signal corresponding to a content selected by a user manipulation from at least one content displayed on the user interface screen, and to control the communicator to transmit, to the server, a content request signal for transmitting the selected content from the server to the display apparatus.

6. The user terminal apparatus of claim 3, wherein the content request signal comprises connection information for communicating with the display apparatus.

7. The user terminal apparatus of claim 1, wherein the context information of the display apparatus comprises at least one from among information on a content currently displayed on the display apparatus, information on a viewing history, and information on a power status, and
wherein the additional information comprises at least one from among information on a recommended content related to the displayed content, information on a preference based on the viewing history, and information on a display mode based on the power status.

8. A system comprising:
a display apparatus;
a user terminal apparatus configured to control the display apparatus; and
a server configured to communicate with at least one of the user terminal apparatus and the display apparatus,
wherein the user terminal apparatus is configured to determine whether to receive additional information from the server based on context information of the display apparatus received from the display apparatus, and to transmit a signal for controlling a status of the display apparatus based on at least one of the context information and the additional information to the display apparatus.

9. The system of claim 8, wherein, in response to the additional information being received, the user terminal apparatus is configured to transmit, to the server, a content request signal for transmitting a content from the server to the display apparatus,
wherein the server is configured to transmit content corresponding to the received content request signal to the display apparatus, and
wherein the display apparatus is configured to display the received content.

10. The system of claim 9, wherein the content request signal comprises connection information for communicating with the display apparatus.

11. The system of claim 8, wherein the server is configured to receive information on user activity performed in the user terminal apparatus by communicating with the user terminal apparatus, generate user preference information based on the information on the user activity and a content displayed on the display apparatus, and transmit information on a content recommended based on the user preference information to the display apparatus.

12. The system of claim 11, wherein the server is configured to determine whether the information on the user activity has a positive relation or negative relation to the displayed content, and generate the user preference information based on the determined relation.

13. A control method of a user terminal apparatus, the control method comprising:
receiving context information of a display apparatus from the display apparatus;
determining whether to receive additional information from the server based on the received context information; and
transmitting, to the display apparatus, a signal for controlling a status of the display apparatus based on at least one of the context information and the additional information.

14. The control method of claim 13, wherein the transmitting comprises, in response to the additional information being received from the server, transmitting, to the display apparatus, a content reproduction signal for reproducing a predetermined content in the display apparatus based on the received additional information and the context information.

15. The control method of claim 14, further comprising transmitting, to the server, a content request signal for transmitting the predetermined content from the server to the display apparatus based on the received additional information.

16. The control method of claim 15, further comprising displaying a user interface screen comprising at least one content based on the received additional information.

17. The control method of claim 16, further comprising transmitting, to the display apparatus, a content reproduction signal corresponding to a content selected by a user manipulation from at least one content displayed on the user interface screen, and transmitting, to the server, a content request signal for transmitting the selected content from the server to the display apparatus.

18. The control method of claim 15, wherein the content request signal comprises connection information for communicating with the display apparatus.

19. The control method of claim 13, wherein the context information of the display apparatus comprises at least one from among information on a content currently displayed on the display apparatus, information on a viewing history, and information on a power status, and
wherein the additional information comprises at least one from among information on a recommended content related to the displayed content, information on a preference based on the viewing history, and information on a display mode based on the power status.

20. A non-transitory computer readable medium comprising computer executable instructions executable by a processor to perform:
receiving, from a display apparatus, context information of the display apparatus;
determining whether to retrieve additional information from the server based on the received context information; and
transmitting a content reproduction signal to cause the display apparatus to reproduce a predetermined content based on the retrieved additional information and the context information.
